(19) United States
(12) Patent Application Publication
(10) Pub. No.: US 2006/0085307 A1
(43) Pub. Date: Apr. 20, 2006

(54) Service billing method in a communication network

(75) Inventors: Bertolt Eicke, Berlin (DE); Uwe Klatt, Oslo (NO); Thomas Ryll, Wolfsburg (DE)

Correspondence Address: MORRISON & FOERSTER LLP, 1650 TYSONS BOULEVARD, SUITE 300, MCLEAN, VA, 22102, US

(73) Assignee: AIEMENS AKTIENGESELLSCAFT, Munchen (DE)

(21) Appl. No.: 10/543,830

(22) PCT Filed: Jan. 15, 2004
(86) PCT No.: PCT/EP04/00261

§ 371 Date: Jul. 29, 2005

(30) Foreign Application Priority Data
Jan. 30, 2003 (DE) 103037047

(51) Int. Cl. G07F 19/00; H04M 15/00

(52) U.S. Cl. 705/34

(57) ABSTRACT

The present invention is directed to a method for service billing within a communication network, in which the billing system thereof requests a price list from the used service in order to determine an invoice sum for price recording system of said communication network. The invoice sum is determined by said billing system, and reserved on the billing account of the subscriber. At the end of the service use, the reserved invoice sum is checked by the billing system such that the invoice sum is determined again, and the reserved invoice sum is updated for any differences, In addition, at the end of the service use, the reserved invoice sum can be updated for a value which is set up in accordance to other parameters compatible to the subscriber, in particular, to the price and/or quantity reduction.

### CLAIM FOR PRIORITY

This application claims the benefit of priority to German Application No. 103 03 704.7 which was filed in the German language on Jan. 30, 2003, the contents of which are hereby incorporated by reference.

### TECHNICAL FIELD OF THE INVENTION

The invention relates to a method for service billing within a communication network.

### BACKGROUND OF THE INVENTION

One of the following billing methods is as a rule employed in connection with the use of services in the area of information and communication. With one method, the charges for services used are summated and periodically invoiced to the service user (what is termed a postpaid method). With the other method, the charges due for the services to be used are paid by the users in advance (what is termed a prepaid method).

A technical distinction is made in billing between what is termed rating, which is to say determining the tariff or price to be applied to a service, and what is termed charging, which is to say the actual billing. For users periodically receiving an invoice (what are termed postpaid users), the billing, which is to say establishing a total amount and dispatching the written invoice to the user, as a rule takes place at the end of the invoicing period.

Once a check has to be carried out for a user of an information network or, as the case may be, communication network prior to service provisioning by the provider of information and communication services in order to determine whether, for instance, the user's credit on what is termed the prepaid account has been exhausted or not, rating, as it is termed, must also take place before the end of service provisioning. After what is termed rating has been carried out, an amount determined from the tariff is reserved on the user's charge account through what is termed the charging process so it can be ensured that the user will be able to make full payment for the service to be provided. As a result, it may in certain circumstances no longer be possible to perform billing for activities possibly running in parallel.

A distinction is made in this what is termed charging process, described above, between what is termed session charging (session-dependent billing) and what is termed event charging (event-dependent billing). The type of billing termed event charging is characterized in its being foreseeable before a service starts being used how service use will appear. What is concerned in this case is a specific event such as, for example, sending a short message via the SMS (Short Message Service) service. This what is termed session charging is characterized in that the end (referred to the time, for instance) is not foreseeable prior to or, as the case may be, at the start of service use so that billing in units, for example time units or data volume units, takes place continuously during service use such as in the case of, say, a voice telephone service which is billed in time units, for example in minutes.

The charging systems and rating systems described are implemented separately in present-day information and communication networks and so have to interact with each other prior to or, as the case may be, during or, as the case may be, following service use. Telecommunication standards for interfaces between charging systems and rating systems of said type are currently under discussion within the scope of UMTS Release 6 of the 3GPP (3rd Generation Partnership Project).

Present-day implementations in which a charging system interacts with a rating system are employed for what is termed session charging and what is termed event charging. For what is termed session charging it is necessary, for the reasons cited, for the charging system or, as the case may be, billing system and the rating system or, as the case may be, system for tariff storage to communicate with each other possibly several times during service use by a user in order to handle billing correctly. If, for example, a tariff changeover (for example from a daytime to an evening tariff) has to take place for the user at a specific time while service use is in progress, the rating system, as it is termed, will have to determine a new tariff to be applied to said user. The rating system is normally only called up by what is termed the charging system prior to or, as the case may be, during service use. The previous rating systems or, as the case may be, charging systems offer no or, as the case may be, only little potential for implementing further tariff structuring or, as the case may be, charge structuring for a service use:
It has to date not been possible to implement what is termed “bundling”, which is to say a reduction in the total price of several products or, as the case may be, services within a joint offer for the user.
It is currently not possible to implement models such as, for instance, what is termed “tiered rating”, whereby the price of a service-use session is dependent on said session's total duration and there are no details about partial billing such as, say, prices for minutes.

For billing during service use, several interrogations of the valid tariff amount are, moreover, necessary from what is termed the rating system, with stringent demands being placed on said rating system's response characteristics in order to achieve an adequate level of performance ensuring acceptable charging system response times.

### SUMMARY OF THE INVENTION

The invention discloses a service billing method that improves the performance level of billing and increases flexibility in terms of implementing further tariff models. Disclosing components or, as the case may be, systems for implementing the improved method is a further object of the invention.

In one embodiment of the invention, upon termination of the use of a service, a concluding tariff interrogation is performed that will enable the charge amount to be correctively adjusted. The method according to the embodiment includes, for example:
Prior to and/or during a use of a service by a user, the tariff amount applicable to the service used is requested from a tariff storage system by a billing system for determining the charge amount,
the anticipated charge amount is determined by the billing system as a function of the anticipated duration of usage, the quality and/or quantity of the service, and of the requested tariff amount obtained, then reserved for debiting purposes on a charge account of the user using the service,
on termination of the use of the service the reserved charge amount is checked by the billing system by re-determining the charge amount as a function of the actual duration of usage and/or quality and/or quantity of the service used, and of the requested applicable tariff amount, and by then correcting the reserved charge amount if there is a difference between the determined charge amounts and the differential amount.

The duration of usage is preferably subdivided into what is termed time units, for example one or three minutes. The quantity of the service used can be specified on the basis of the maximum data volume that can be transmitted, for example one or five Mbytes. The quality of the service (QoS: Quality of Service) can also be specified.

Further billing parameters are conceivable which will either influence the applicable tariff or, as the case may be, reduce the charge amount. Conceivable in particular are price discounts associated with a rebate or with the “bundling” cited at the beginning or in association with playing advertising programs or, as the case may be, price discounts that are bulk discounts.

If the anticipated duration of usage has been subdivided into time units, the above-described check on the reserved charge amount will be repeated after each time unit or a predefined number of time units. The above-described check on the reserved charge amount can also be repeated after a predefined maximum volume of data that can be transmitted.

The method according to the invention has the following advantages:
Special tariff models such as, for example, what is termed tiered rating can be implemented. Owing to the fact that the price of a service session is dependent on the total duration of the session and that there are no details about partial billing, the concluding price of or, as the case may be, charge for the session can only be determined at the end thereof. Before that it is only possible to make assumptions. The previously anticipated charge amount may have to be corrected owing to a quality of service deviating from that previously assumed or, as the case may be, anticipated, with the anticipated charge amount requiring to be reserved having to be selected in such a way as to avoid insufficient coverage by the user's charge account especially in the case of prepaid customers.
Service features such as, for instance, quality of service that can only be determined after the service has been provided can be used for determining the charge. New customer retention programs such as, for example, what are called cross-product discounts (discounts for a product that are based on using another product. “After sending the 50th SMS this month you will be given a 5% discount on each voice call made”.) can be effectively implemented.
Tariff interrogation operations (rating) that are not realtime-dependent can be decoupled from actual service use and will be dealt with in less time-critical areas after a service has been used. Prioritizing can take place on the rating system side so that the systems involved are used more efficiently and hence the costs for the operator of the systems will be lower.
Tariff parameters can be interrogated prior to and during service use. Performance will be enhanced owing to fewer tariff interrogations or, as the case may be, price inquiries. At the same time, flexible price discount models will be made possible by the method according to the invention.

### BRIEF DESCRIPTION OF THE DRAWINGS

The invention is described in more detail below with reference to exemplary embodiment and the drawings, in which:

FIG. 1 shows a communication network to which the method and devices according to the invention can be applied.

### DETAILED DESCRIPTION OF THE INVENTION

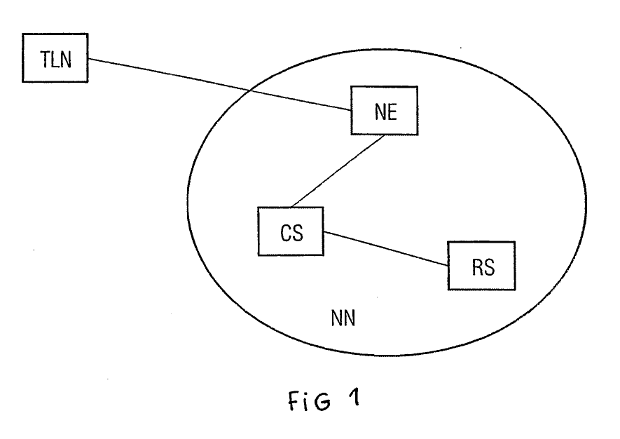

FIG. 1 is a communication network NN within which the method according to the invention is applied. A user TLN wishes to use a service offered to the user directly or indirectly by a network operator (indicated by the network element NE) and addresses the network element, for example what is termed a mobile switching center (MSC) if the network is a mobile communication network or, as the case may be, a switching center if the network is a fixed network. The network element NE is here responsible for switching voice services. The NE can also make services of other providers available and perform their billing via the billing system CS and tariff storage system RS. If the user is what is termed a prepaid user, the network element will detect that a cost check will be necessary for this user before service use has been concluded. The network element consequently addresses a billing system (charging system) CS, which in turn requests the applicable tariff amount from a possibly central tariff storage system RS (rating system).

In this connection, the method according to the invention is performed as follows:
For service use by the prepaid user, a connection, for example what is termed a Voice-over-IP connection, is set up between the subscriber line or, as the case may be, subscriber's terminal equipment and the network element NE.
Prior to or during the connection the billing system specifies the valid tariff amount (depending, say, on the origin, destination, and time of day), which it obtains from the tariff storage system.
The tariff amount can be made known to the user if the user so requests.
The billing system specifies an initial time unit (three minutes, say) or the maximum data volume that can be transmitted (for example 1 Mbyte) and reserves on the user's charge account a charge amount to be debited that is determined from the time unit or, as the case may be, the volume of data that can be transmitted as well as from the tariff amount.
When one or more time units have expired or the maximum data volume that can be transmitted has been reached, the charge amount will be debited to the user's charge account and a new charge amount reserved. A further request for the current tariff amount from the tariff storage system will not as a rule be necessary unless there is a tariff changeover. Relevant data such as the actual duration of usage, the quantity in the form of the volume of data transmitted, as well as the quality of service (QoS) will be available on termination of service use and of the connection set up therefor.
On termination of service use the billing system will check the reserved charge amount to be debited and request further billing parameters from the tariff storage system. Apart from the current tariff amount, the result can include further data, for example a price discount due to a shortfall in quality for the service or due also to advertising programs played by the user. It is furthermore possible at this instant to interrogate data resulting in discounted charges for services to be provided later, such as, for instance, bulk discounts, rebates, or what is termed “bundling”. If there is a difference between the originally reserved charge amount and the actual charge amount based on the duration of usage and on the quality of service or, as the case may be, on the volume of data transmitted or, as the case may be, on the other billing parameters described above, in order to correct the differential amount. Less stringent demands will be placed here on the response characteristics of the tariff storage system. There is no risk that insufficient funds will be available on the prepaid user's charge account.

Both the billing system CS and the tariff storage system RS are embodied in such a way as to provide support for the administration of the reserved charge amounts or, as the case may be, preferential tariff amounts as well as corrective adjustment of the funds actually to be debited.

1. A method for service billing within a communication network, comprising:
requesting, prior to and/or during use of a service by a user of the communication network, the tariff amount to be applied to the service used for determining the charge amount from a tariff storage system of the communication network by a billing system of the communication networks;
determining the anticipated charge amount by the billing system as a function of the anticipated duration of usage, the quality and/or quantity of the service, and of the requested tariff amount obtained, then reserved for debiting purposes on a charge account of the user using the service;
checking, on termination of the use of the service, the reserved charge amount by the billing system by re-determining the charge amount as a function of the actual duration of usage and/or quality and/or quantity of the service used, and of the requested applicable tariff amount, and by correcting the reserved charge amount if there is a difference between the determined charge amounts and the differential amount.

2. The method as claimed in claim 1, wherein the applicable tariff amount is requested from the tariff storage system the checking is performed.

3. The method as claimed in claim 1, wherein the anticipated duration of usage of the service used by the user is specified in time units before the service starts being used.

4. The method as claimed in claim 1, wherein the chekcing is repeated after one or more predefined time units.

5. The method as claimed in claim 1, wherein an anticipated quantity of the service used by the user is specified, before the service starts being used, in terms of the maximum volume of data that can be transmitted.

6. The method as claimed in claim 1, wherein the checking is repeated after a predefined maximum volume of data that can be transmitted.

7. The method as claimed in claim 1, wherein on termination of service use the reserved charge amount will be corrected by an amount that has been specified as a function of further billing parameters agreed with the user.

8. A billing system implementing the following:
requesting, prior to and/or during use of a service by a user of the communication network, the tariff amount to be applied to the service used for determining the charge amount from a tariff storage system of the communication network by a billing system of the communication network;
determining the anticipated charge amount by the billing system as a function of the anticipated duration of usage, the quality and/or quantity of the service, and of the requested tariff amount obtained, then reserved for debiting purposes on a charge account of the user using the service;
checking, on termination of the use of the service, the reserved charge amount by the billing system by re-determining the charge amount as a function of the actual duration of usage and/or quality and/or quantity of the service used, and of the requested applicable tariff amount, and by correcting the reserved charge amount if there is a difference between the determined charge amounts and the differential amount.

9. A tariff storage system implementing the following:
requesting, prior to and/or during use of a service by a user of the communication network, the tariff amount to be applied to the service used for determining the charge amount from a tariff storage system of the communication network by a billing system of the communication network;
determining the anticipated charge amount by the billing system as a function of the anticipated duration of usage, the quality and/or quantity of the service, and of the requested tariff amount obtained, then reserved for debiting purposes on a charge account of the user using the service;
checking, on termination of the use of the service, the reserved charge amount by the billing system by re-determining the charge amount as a function of the actual duration of usage and/or quality and/or quantity of the service used, and of the requested applicable tariff amount, and by correcting the reserved charge amount if there is a difference between the determined charge amounts and the differential amount.
